(19) United States
(12) Patent Application Publication
(10) Pub. No.: US 2008/0285255 A1
(43) Pub. Date: Nov. 20, 2008

(54) Low birefringent light redirecting film

(75) Inventors: Robert P. Bourdelais, Pittsford, NY (US); Cheryl J. Brickey, Rochester, NY (US); Steven J. Neerbasch, Rochester, NY (US)

Correspondence Address: Edwin Oh;Rohm and Haas Electronic Materials LLC, 455 Forest Street, Marlborough, MA, 01752, US

(73) Assignee: Rohm and Haas Denmark Finance A/S, Copenhagen (DK)

(21) Appl. No.: 12/218,103

(22) Filed: Jul. 11, 2008

Related U.S. Application Data
(62) Division of application No. 11/180,942, filed on Jul. 13, 2005.

(51) Int. Cl. F21V 9/14

(52) U.S. Cl. 362/19

(57) ABSTRACT

The invention relates to a polymeric optical film comprising a base provided with integral optical features on at least one side, wherein the features have two or more sides that form a ridge line, wherein the optical film has light leakage through crossed polarizers of less than 1.0%.

### FIELD OF THE INVENTION

This invention relates to the formation of a light redirecting polymeric film comprising a plurality of polymeric integral features. In particular, a light redirecting film having low optical birefringence.

### BACKGROUND OF THE INVENTION

Light redirecting films are typically thin transparent optical films or substrates that redistribute the light passing through the films such that the distribution of the light exiting the films is directed more normal to the surface of the films. Typically, redirecting films are provided with ordered prismatic grooves, lenticular grooves, or pyramids on the light exit surface of the films which change the angle of the film/air interface for light rays exiting the films and caused the components of the incident light distribution traveling in a plane perpendicular to the refracting surfaces of the grooves to be redistributed in a direction more normal to the surface of the films. Such light redirecting films are used, for example, to improve brightness in liquid crystal displays, laptop computers, word processors, avionic displays, cell phones, PDAs and the like to make the displays brighter.

Previous light redirecting films suffer from visible moiré patterns when the light redirecting film is used with a liquid crystal or other display. The surface features of the light redirecting film interact with other optical films utilized in backlight assemblies, the pattern of printed dots or three-dimensional features on the back of the light guide plate, or the pixel pattern inside the liquid crystal section of the display to create moiré, an undesirable effect. Methods known in the art for reducing moiré have been to cut the light redirecting films at an angle relative to themselves or to the display, to randomize the linear array by widths of the linear array elements, to vary the height along the linear array periodically, to add a diffusing layer on the opposite side of the linear array on the film, or to round the peaks of the linear array. The above techniques to reduce moiré also cause a decrease in on-axis brightness or do not work to adequately solve the moiré problem. Moiré and on-axis brightness tend to be related, meaning that a film with high on-axis gain would have high moiré in a system. It would be beneficial to be able to reduce the moiré while maintaining relatively high on-axis gain.

U.S. Pat. No. 5,919,551 (Cobb, Jr. et al) claims a linear array film with variable pitch peaks and/or grooves to reduce the visibility of moiré interference patterns. The pitch variations can be over groups of adjacent peaks and/or valleys or between adjacent pairs of peaks and/or valleys. While this varying of the pitch of the linear array elements does reduce moiré, the linear elements of the film still interact with the dot pattern on the backlight light guide and the electronics inside the liquid crystal section of the display. It would be desirable to break up the linear array of elements to reduce or eliminate this interaction.

U.S. Pat. No. 6,354,709 discloses a film with a linear array that varies in height along its ridgeline and the ridgeline also moves side to side. While the film does redirect light and its varying height along the ridgeline slightly reduces moiré, it would be desirable to have a film that significantly reduces the moiré of the film when used in a system while maintaining a moderately high on-axis gain.

U.S. Application No. 2001/0053075 (Parker et al.) discloses the use of integral features for the redirection of light. Surprisingly, it has been discovered that the careful selection of the design parameters of the integral features produce an unexpected balance between on-axis gain and moiré reduction for certain display configurations that were not anticipated by Parker et al.

U.S. Pat. No. 6,583,936 (Kaminsky et al) discloses a patterned roller for the micro-replication of light polymer diffusion lenses. The patterned roller is created by first bead blasting the roller with multiple sized particles, followed by a chroming process that creates micro-nodules. The manufacturing method for the roller is well suited for light diffusion lenses that are intended to diffuse incident light energy.

Light transmission through a light redirecting film is a critical parameter as high light transmission allows display screens that use light redirecting films to be bright as source light energy is transmitted to the observers' eye. There is a continuing need to provide light redirecting films that have a high degree of light transmission. Polymers that exhibit a high degree of crystallinity generally have lower light transmission than polymers that are less crystalline. Crystallinity in a polymer creates small index of refraction differences in the polymer, allowing for inefficient refraction between the index of refraction changes to occur resulting in a loss in light transmission. Polymers that are amorphous or those polymers that have crystallinity less than 10% are optically clear and therefore have significant commercial value as light redirecting films.

A birefringent polymer is a polymer in which the index of refraction is different either in the plane of the film, or between the plane and thickness axis. Birefringence is the difference of a material's refractive index with direction. It is the opposite of isotropic. Most polymers are optically anisotropic because of the nature of the long macromolecular chains. Depending on the chemical structure, a macromolecule could have a positive or negative birefringence. Polymers with aromatic compounds in the main chain generally have positive birefringence due to large polarize-ability along the chain axis compared with that in the transverse direction. Polymers are subject to flow during extrusion or molding; therefore, the end product is often highly birefringent due to chain orientation and residual stress. This induced birefringence causes undesirable effects in many optical applications such as laser disks, electronic devices and CDs. Common birefringent materials include crystals with non-symmetric atomic spacing (e.g. calcite, sapphire) and oriented polymer films. Some thin polymer films have low in-plane birefringence with higher out-of-plane birefringence. Data is acquired at different incidence angles through these films and can be used to characterize both the in-plane and out-of-plane birefringence for proper viewing-angle compensation.

Birefringence is a problem for LCD displays. LCD displays use plane-polarized light, and the change to elliptical polarization due to birefringence degrades the contrast and other visual characteristics of the displays. Further, reflective polarizers utilized in LCD devices to increase on axis brightness are typically adjacent the absorptive polarizers used in LCD display devices. Any significant change in the transmitted polarization state of light can result in a loss of brightness. Typical light directing films comprising ordered or random prism structures have a high degree of birefringence as typical light direction films contain at least one layer of oriented polymer such as polyester to provide stiffness to the optical film.

U.S. Pat. No. 5,580,950 discloses a class of soluble polymers having a rigid rod backbone, which when used to cast films, undergo a self-orientation process whereby the polymer backbone becomes more or less aligned parallel to a film surface. This in-plane orientation results in a film that displays negative birefringence. The degree of in-plane orientation and thus, the magnitude of the negative birefringence is controlled by varying the backbone linearity and rigidity of the class of polymers through selection of sub-stituents in the polymer backbone chain. By increasing the polymer backbone linearity and rigidity, the degree of in-plane orientation and associated negative birefringence can be increased, and that conversely, by decreasing the polymer backbone linearity and rigidity, the negative birefringence can be decreased.

U.S. Pat. No. 5,759,756 discloses a photographic support including a core layer of a transparent non-crystalline polymer having a glass transition temperature difference compared to a skin layer of polymer such that after stretching, the core has a lower level of crystallinity than the skin layer.

U.S. Pat. No. 6,111,696 (Allen et al.) discloses a brightness enhancement film comprising a dispersed phase of polymeric particles disposed within a continuous birefringent matrix in combination with light directing materials to enable control of light emitted from a light fixture. The polymer film disclosed in U.S. Pat. No. 6,111,696 is oriented to intentionally increase birefringence in the polymer film to reflect one of the polarizations states of visible light energy.

### PROBLEM TO BE SOLVED BY THE INVENTION

There is a need for a light redirecting films that has high on axis brightness while reducing unwanted moiré patterns such that the moiré patterns are not visible when viewing display devices. Further, there is a need for a light redirecting film that has low birefringence.

### SUMMARY OF THE INVENTION

It is an object of the invention to a light redirecting film that reduces moiré while maintaining high optical gain.

It is another object to a light redirecting film that has low propensity to curl.

It is a further object to provide an optical film that provides high display device brightness.

These and other objects of the invention are accomplished by a polymeric optical film comprising a base provided with integral optical features on at least one side, wherein the features have two or more sides that form a ridge line, wherein the optical film has light leakage through crossed polarizers of less than 1.0%.

### ADVANTAGEOUS EFFECT OF THE INVENTION

The invention provides a low birefringent light redirecting film made of individual optical elements that significantly reduce moiré when used in a liquid crystal system while maintaining relatively high on-axis gain. Low birefringent light redirecting films further provide high transmission of polarized light without significantly changing the polarization state of the transmitted light.

### BRIEF DESCRIPTION OF THE DRAWINGS

FIG. 1 is an illustration of a cross section of a preferred combination of optical films utilized in a LCD backlight configuration.

FIG. 2 is a plot of inclination angle vs. luminance of invention example 1 and comparison example 1 and 2.

FIG. 3 is an illustration of a cross section of a preferred combination of optical films utilized in a LCD backlight configuration.

FIG. 4 is a plot of inclination angle vs. luminance of invention example 1 and comparison example 1 and 2.

### DETAILED DESCRIPTION OF THE INVENTION

The invention has numerous advantages compared to prior art light redirecting films. The light redirecting films of the invention have low birefringence, that is the index of refraction in the plane of the redirecting film is roughly equivalent to the index of refraction in the depth of the sheet. Light redirecting film having both redirecting properties and low birefringence allow for transmitted light to be both redirected without substantially changing the polarization state of the transmitted light. Prior art redirecting films utilize oriented polyester as a substrate for UV cured polymer light redirecting lenticular structures. The oriented polyester film is highly birefringent and therefore alters the polarization of transmitted light. A low birefringent light redirecting film allows for redirection of polarized light without substantially changing the polarization state of light. In some LCD device configurations, any significant change in the transmitted polarization state of light can result in a loss of device brightness and contrast. The invention materials provide both light re-direction properties and have a low birefringence solving the problem of simultaneously providing both light directing surface patterns and low birefringence.

The low birefringent redirecting polymer film utilizes polymer materials that have high visible light transmission, which further increases the brightness of display devices that utilize redirecting films. Polymers that exhibit a high degree of crystallinity generally have lower light transmission and have higher birefringence than polymers that are less crystalline. Crystallinity in a polymer creates small index of refraction differences in the polymer, allowing for inefficient refraction between the index of refraction changes to occur resulting in a loss in light transmission. Polymers that are amorphous or those polymers that have crystallinity less than 10% are optically clear and therefore have significant commercial value as redirecting film materials particularly for LCD display devices that at present are brightness challenged.

The redirecting film's wedge shaped individual optical elements' sizes and placement on the film balance the tradeoffs between moiré reduction and on-axis gain producing relatively high on-axis gain while significantly reducing moiré. Moiré patterns result when two or more regular sets of lines or points overlap. In a display device such as a LCD display, moiré patterns that can be observed by the viewer of the LCD device are objectionable as they interfere with the quality of the displayed information or image. The light redirecting film of the invention reduces moiré compared to prior art light redirecting films while maintaining high on-axis optical gain.

Because the film of the invention is a unitary structure of polymer, there are fewer propensities to curl. When the film is made of two layers, it has a tendency to curl because the two layers typically react differently (expand or contact) to different environmental conditions (for example, heat and humidity). Curl is undesirable for the light redirecting film in an LCD because it causes warping of the film in the display that can be seen through the display. Further, warping of optical films changes the angle of incident light energy causing a loss in optical efficiency. The invention utilizes polymers that resist scratching and abrasion and have been shown to be mechanically tougher compared to prior art optical films constructed from delicate UV cured polyacrylate.

The light redirecting film, because the individual optical elements are curved wedge shaped features can redirect a portion of the light traveling in a plane parallel to the ridgelines of the elements. Furthermore, the light redirecting film of the invention can be customized to the light source and light output of the light guide plate in order to more efficiently redirect the light. The individual optical elements make the film very flexible in design parameters, allowing different individual optical elements or different size or orientation to be used throughout the film surface to process the light entering the film the most efficiently. For example, if the light output as a function of angle was known for all points of a typical LCD light guide plate, a light redirecting film using curved wedge shaped features having different shapes, sizes, or orientation, could over the surface area the film, be used to more efficiently process the light exiting the light guide plate by changing the shape of each lens to optimize light output as a function of location on the light guide plate. These and other advantages will be apparent from the detailed description below.

The term as used herein, “transparent” means the ability to pass radiation without significant deviation or absorption. For this invention, “transparent” material is defined as a material that has a spectral light transmission greater than 90%. The term “light” means visible light. The term “polymeric film” means a film comprising polymers. The term “polymer” means homo-polymers, co-polymers, block co-polymers and polymer blends. Examples of polymers having high light transmission include cellulose triacetate, polycarbonate and amorphous polyesters.

The term “optical gain”, “on axis gain”, or “gain” means the ratio of output light intensity divided by input light intensity. Gain is used as a measure of efficiency of a redirecting film and can be utilized to compare the performance light redirecting films against each other.

Individual optical elements, in the context of an optical film, mean elements of a well-defined shape that are projections or depressions in the optical film. Individual optical elements are small relative to the length and width of an optical film. The term “curved surface” is used to indicate a three dimensional feature on a film that has curvature in at least one plane. “Wedge shaped features” is used to indicate an element that includes one or more sloping surfaces, and these surfaces may be combination of planar and curved surfaces. One example of a wedge shaped feature is a citrus orange segment having two planer surfaces and a curved surface along the length of the orange segment.

The term “optical film” is used to indicate a thin polymer film that changes the nature of transmitted incident light. Generally, optical films are thin, having a thickness less than 750 micrometer and are able to be bent. Optical films typically perform an optical function. For example, a redirecting optical film provides an optical gain (output/input) greater than 1.0, typically 1.40. The term “polarization” means the restriction of the vibration in the transverse wave so that the vibration occurs in a single plane. The term “polarizer” means a material that polarizes incident visible light.

To determine the integrated birefringence of a textured or smooth surface polymer film, two thin film transistor (TFT) grade absorptive polarizers are crossed and a total light transmission measurement (measured at 550 nanometers) was taken at the normal to the films. Un-polarized light is incident on the first absorptive polarizer and the detector is behind the second absorptive polarizer. If the absorptive polarizers were perfect, one would expect 0% of the light to exit the crossed polarizers normal to the surface of the polarizers. The percent total light transmission at the normal to the films for typical crossed TFT LCD grade absorptive polarizers was measured at 0.03%, which indicates some small acceptable lack of efficiency of the TFT grade absorptive polarizers. The term “light leakage” is the amount of visible light energy leaking or transmitted from cross TFT grade LCD polarizers when a polymer film is placed between the cross TFT grade cross polarizers. For comparison purposes, typical un-patterned 80 micrometer TFT grade triacetate cellulose (TAC) located between two-crossed TFT grade polarizers would have a visible light leakage of between 0.03% and 0.06%. Further, a sheet of oriented un-patterned 80 micrometer PET film between the same crossed polarizers would have a light leakage of between 5 and 35%, depending on the type of PET polymer and the degree of orientation of the PET. Crossed TFT grade polarizers are used to evaluate the birefringence of structured or patterned polymer films because, at the time of writing, direct measurement of the birefringence of structured film is difficult.

The terms “planar birefringence” and “birefringence” as used herein is the difference between the average refractive index in the film plane and the refractive index in the thickness direction. That is, the refractive index in the machine direction and the transverse direction are totaled, divided by two and then the refractive index in the thickness direction is subtracted from this value to yield the value of the planar birefringence. Refractive indices are measured using an Abbe-3L refractometer using the procedure set forth in Encyclopedia of Polymer Science & Engineering, Wiley, N.Y., 1988, pg. 261. The term “low birefringence” means a material that produces small changes in the polarization state of light and is confined to polymer web material that has a birefringence less than 0.01 and will have a light leakage between two crossed TFT grade polarizers of less than 1.0%.

An amorphous polymer is a polymer that does not exhibit melting transitions in a standard thermogram generated by the differential scanning calorimetry (DSC) method. According to this method (well known to those skilled in the art), a small sample of the polymer (5-20 mg) is sealed in a small aluminum pan. The pan is then placed in a DSC apparatus (e.g., Perkin Elmer 7 Series Thermal Analysis System) and its thermal response is recorded by scanning at a rate of 10-20° C./min from room temperature up to 300° C. Melting is manifested by a distinct endothermic peak. The absence of such peak indicates that the test polymer is functionally amorphous. A stepwise change in the thermogram represents the glass transition temperature of the polymer.

In order to accomplish a polymeric redirecting film that is both low in birefringence and able to redirect transmitted light a polymeric optical film comprising a base provided with integral optical features on at least one side, wherein the features have two or more sides that form a ridge line, wherein the optical film has light leakage through crossed polarizers of less than 1.0%. The integral surface features or lenses of the invention provide for the efficient redirecting of transmitted light. Polymer features that that have two or more sides that form a ridge line have been shown to provide efficient redirecting of light by recycling light entering the features at shallow angles relative to the base of the redirecting film. A film that has a light leakage through cross polarizers of less than 1.0% has been shown to allow for the redirection of polarized light without substantially changing the polarization state of light. Prior art light redirecting films utilizing oriented polymer sheet have light leakage between crosses polarizers of between 5 and 35% and have been shown to significantly change the polarization state of polarized light. Redirecting film birefringence and the magnitude of the change in polarization state of transmitted light are correlated. Increasing redirecting film birefringence increases the magnitude of the change in polarization state of transmitted light. By reducing the birefringence of the redirecting film the changes in the polarization state of transmitted light is significantly reduced over prior art redirecting films.

Patterned optical films, in particular, light direction films typically have a high degree of birefringence because the process of patterning typically involves subjecting the polymer to mechanical stress. The amount of birefringence contained in a polymer film is proportional to the amount of mechanical stress the polymer film is subjected. The invention utilizes both a low birefringent polymer and utilizes a method of pattern formation that minimizes the amount of stress that the light direction film is subjected. In one preferred embodiment of the invention, the low birefringent light direction film comprises patterned TAC polymer formed by solvent embossing the pattern into the TAC while the TAC contains 25% by weight of solvent.

In another embodiment of the invention, the light leakage of the light redirecting film is preferably between 0.05 and 0.5%, more preferably between 0.05 and 0.2%. By reducing the amount of light leakage through cross polarizers, the amount of the changes in the polarization state of transmitted light is reduced, thereby increasing the utilization of polarized light generated by light sources such as CCFL backlights and LED backlights.

Preferably the birefringence of the redirecting film is between 1.0×10⁻⁵ to 5.0×10⁻³. A birefringence between 1.0×10⁻⁵ and 5.0×10⁻³ has been shown to allow for the light redirecting of polarized light without substantially changing the polarization state of light. This range of birefringence has been shown to be an acceptable trade-off between manufacturing efficiency and the magnitude of the change in the polarization state of transmitted light.

The depth of the integral features in the optical film is preferably between 10 and 50 micrometers. The depth of the curved integral features is measured from the ridge of the curved integral features to the base of the curved integral features. A feature depth less than 8 micrometers results in a redirecting film with low brightness because of the relative high amounts of un-patterned areas of the film located at the apex areas of the light direction features. A depth greater than 55 micrometers is difficult to manufacture and contains features large enough to create a moiré pattern.

The integral features in the optical film preferably have a width of between 20 and 100 micrometers. When the elements have a width of greater than 130 micrometers, they become large enough that the viewer can see them through the liquid crystal display, detracting from the quality of the display. When the elements have a width of less than 12 micrometers, the width of the ridgeline of the feature takes up a larger portion of the width of the feature. This ridgeline is typically flattened and does not have the same light shaping characteristics of the rest of the element. This increase in amount of width of the ridgeline to the width of the element decreases the performance of the film. More preferably, the curved integral features have a width of between 15 and 60 micrometers. It has been shown that this range provides good light shaping characteristics and cannot be seen by the viewer through a display. The specific width used in a display device design will depend, in part, on the pixel pitch of the liquid crystal display. The element width should be chosen to help minimize moiré interference.

The length of the integral features on the optical film as measured along the protruding ridge is preferably between 800 and 3000 micrometers. As the long dimension lengthens the pattern becomes one-dimensional and a moiré pattern can develop. As the pattern is shortened the screen gain is reduced and therefore is not of interest. This range of length of the curved integral features has been found to reduce unwanted moiré patterns and simultaneously provide high on-axis brightness.

In another preferred embodiment, the integral features on the optical film as measured along the protruding ridge is preferably between 100 and 600 micrometers. As the long dimension of the integral features is reduced, the tendency to form moiré patterns is also reduced. This range of integral feature length has been shown to significantly reduce unwanted moiré patterns encountered in display devices while providing on-axis brightness.

The integral features of the invention are preferably overlapping. By overlapping the curved integral features, moiré beneficial reduction was observed. Preferably, the curved integral features of the invention are randomly placed and parallel to each other. This causes the ridges to be generally aligned in the same direction. It is preferred to have generally oriented ridgelines so that the film redirects more in one direction than the other which creates higher on-axis gain when used in a liquid crystal backlighting system. The curved integral features are preferably randomized in such a way as to eliminate any interference with the pixel spacing of a liquid crystal display. This randomization can include the size, shape, position, depth, orientation, angle or density of the optical elements. This eliminates the need for diffuser layers to defeat moiré and similar effects.

At least some of the integral features may be arranged in groupings across the exit surface of the films, with at least some of the optical elements in each of the groupings having a different size or shape characteristic that collectively produce an average size or shape characteristic for each of the groupings that varies across the films to obtain average characteristic values beyond machining tolerances for any single optical element and to defeat moiré and interference effects with the pixel spacing of a liquid crystal display. In addition, at least some of the integral features may be oriented at different angles relative to each other for customizing the ability of the films to reorient/redirect light along two different axes. It is important to the gain performance of the films to avoid planar, un-faceted surface areas when randomizing features. Algorithms exist for pseudo-random placement of these features that avoid unfaceted or planar areas.

Preferably, the integral features have a cross section indicating an approximate 90 degree included angle at the highest point of the feature. It has been shown that a 90 degree peak angle produces the highest on-axis brightness for the light redirecting film. The 90 degree angle has some latitude to it, it has been found that an angle of 88 to 92 degrees produces similar results and can be used with little to no loss in on-axis brightness. When the angle of the peak is less than 85 degrees or more than 95 degrees, the on-axis brightness for the light redirecting film decreases. Because the included angle is preferably 90 degrees and the width is preferably 15 to 30 micrometers, the curved wedge shaped features preferably have a maximum ridge height of the feature of between 7 and 30 micrometers. It has been shown that this range of heights of the wedge shaped elements provide high on-axis gain and moiré reduction.

The integral features on the optical film have an average pitch of between 10 and 55 micrometers. The average pitch is the average of the distance between the highest points of two adjacent features. The average pitch is different than the width of the features because the features vary in dimension and they are overlapping, intersecting, and randomly placed on the surface of the film to reduce moiré and to ensure that there is no un-patterned area on the film. It is preferred to have less than 0.1% un-patterned area on the film, because un-patterned area does not have the same optical performance as the wedge shaped elements, leading to a decrease in performance.

Preferably, the polymeric film of the invention has an on-axis gain of between 1.3 and 2.0. The light redirecting film of the invention balances high on-axis gain with reduced moiré. It has been shown that an on-axis gain of at least 1.3 is preferred by LCD manufacturers to significantly increase the brightness of the display. An on-axis gain greater than 2.2, while providing high gain on axis, has a very limited viewing angle. Furthermore, an on-axis gain greater than 2.2 provided by the integral features causes a high degree of recycling in a typical LCD backlight resulting in an overall loss in output light as light recycling in a LCD backlight has loss due to absorption, unwanted reflection and light leaking out the sides of a typical LCD backlight unit.

The redirecting film containing integral features preferably has a half angle of between 10 and 60 degrees. Half angle is defined as angle created from intersection of a line normal to the redirecting film and a line drawn through the point at which the illumination is 50% of the on axis-brightness to the redirecting film. The half angle describes the radial distribution of brightness, defining the point at which the brightness is decreased by 50%. A half angle greater than 70 degrees utilizing integral features to enhance the brightness of incident light has been shown to not provide sufficient on axis brightness. A half angle of less than 8 degrees, while providing relatively high on axis brightness, suffers from recycling inefficiency and does not provide wide enough illumination for wide viewing application such as television.

Preferably the surfaces of the integral features have roughness less than 30 nanometers. Surface roughness is a measure of the average peak to valley distance for surface roughness. Surface roughness of the redirecting film is directly related to the surface roughness of the tool utilized to form the precision integral features. Surface roughness can result from a worn tool, high tool feed rates or damage to the precision tooling surface. Surface roughness greater than 35 nanometers has been shown to reduce the redirecting efficiency of the integral features. Surface roughness of the integral features less than 5 nanometers is not cost justified compared to the incremental increase in light output.

The surface roughness of the side opposite the integral features preferably has surface roughness less than 30 nanometers. The surface roughness of the side opposite the integral features can result from polymer casting surface roughness, unwanted shrinking of the polymer or surface scratches during transport of the redirecting film. Surface roughness greater than 35 nanometers has been shown to reduce the overall output of the light redirecting film by creating unwanted diffuse reflection of incident light and reducing the efficiency of the total internal reflection (TIR) of the optical film. A surface roughness on the side opposite the integral features less than 5 nanometers is not cost justified compared to the relatively small increase in light output.

It has been shown that polymers that are subjected to mechanical flow during extrusion or molding often are highly birefringent due to chain orientation and residual stress contained in the polymer after the polymer cools below the Tg of the polymer. In an embodiment of the invention, the polymeric optical film having integral features comprises cellulose triacetate. Cellulose triacetate has both high optical transmission and low optical birefringence allowing the light redirecting film of the invention to both redirect light and have low birefringence. Further, cellulose triacetate can be solvent cast and the integral features of the invention can be formed while the cellulose triacetate has residual solvent content significantly reducing stress/strain induced birefringence.

In another preferred embodiment, the polymer film with integral features comprise materials selected from the following, poly(methyl methacrylate), polystyrene, poly(phenylene oxide), styrene acrylonitrile copolymer (SAN), cyclo-olefin polymer, poly(methyl pentene), polycarbonate and mixtures thereof. The above polymers exhibit high visible light transmission compared to more crystalline polymers and can be formed into the light redirecting feature geometry of the invention.

A light redirecting film that both redirects light and has low birefringence is valuable in increasing the brightness of a LCD display device. An LCD device comprising at least one sheet of polymeric optical film comprising integral features, wherein the features have two or more sides that form a ridge line. While one sheet of redirecting film has been shown to provide a increase in on-axis brightness gain of between 1.2 and 1.35, a second sheet, rotated 90 degrees relative to the first sheet has been shown to further increase the brightness an additional 10 to 35% compared to a single sheet of redirecting film. Five or more light redirecting films utilized in the device are not cost justified as a method of increasing on-axis brightness.

In another preferred embodiment the polymeric optical film is located between a reflective polarizer and a first absorptive polarizer of said liquid crystal display device. Since the light redirecting film is low in birefringence, a reflective polarizer can be located nearer the light guide plates utilized in LCD displays. Prior art LCD display devices typically contain the following optical film stack. The film stack pictured below shows the relative order of the optical films. The optical films listed below are not physically or chemically adhered to each other.

First absorptive polarizer
Reflective polarizer
Light redirecting film(s)
Light diffuser
Light guide plate

Since prior art light redirecting films have birefringence of approximately 0.1, prior art light redirecting films significantly change the polarization state of transmitted light. Locating a prior art light redirecting film adjacent the light guide plate would reduce the on axis brightness of the system between 10 and 60%. In a preferred embodiment, the optical film stack of the LCD backlight is as follows:

First absorptive polarizer
Low birefringence light redirecting film(s)
Reflective polarizer
Light diffuser
Light guide plate

In a further embodiment of the invention, a LCD device comprises the polymeric optical film located between a polarizing light guide plate and the first occurrence of an absorptive polarizer. Polarizing light guides plates are known and generally emit the majority of light in one of the polarization states of light. Further, it has been shown that extruded or molded acrylic tapered wave guide plates are between 2 and II % polarizing. By locating a redirecting film that is low in birefringence between the first occurrence of an absorptive polarizer and the polarizing light guide plate, the use of a reflective polarizer can be eliminated thereby saving materials cost, reducing both the thickness and weight of a reflective polarizer and eliminating reflection and absorptions losses suffer by prior art reflective polarizers. A preferred optical film stack is as follows:

First absorptive polarizer
Low birefringence light redirecting film
Polarizing wave guide plate

Birefringence is a problem for LCD displays. LCD displays use plane-polarized light, and the change to elliptical polarization due to birefringence degrades the contrast and other visual characteristics of the displays. Prior art LCD device manufacturers take great care to ensure that materials utilized between the two absorptive polarizers have very low or no birefringence. By providing a light redirecting film that can both redirect light and have low birefringence, the light redirecting film is preferable located between the first and second absorptive polarizer. The integral features of the invention can redirect polarized light as it enters the liquid crystal cells. The integral features are preferably designed to reduce light incident the TFT arrays and associated electronics thereby increasing the amount of transmitted light through the liquid crystal cell. A preferred optical film stack is as follows:

Second absorptive polarizer
Liquid crystal cells
Low birefringence redirecting film
First absorptive polarizer

The light redirecting optical film having low birefringence is preferably manufactured utilizing a process that reduces stress/strain on the polymer during formation of the optical film. A process of forming a low birefringent light-redirecting film comprising solvent casting a low birefringent polymer, partially evaporating the solvent, embossing the polymer to form integral features, wherein the features have two or more sides that form a ridge line, wherein the optical film has a birefringence of between 0 and 0.01 is preferred. By solvent casting polymer on to a casting surface, the stress/strain on the low birefringent polymer is very low, resulting in an optical film with low birefringence compared to polymers that during processing, are exposed to high stress/strain, which generally increases birefringence of the polymer.

In preferred embodiment of the invention, the solvent coated polymer contains between 15 and 40% solvent by weight of polymer. It has been shown that by retaining residual solvent between 15 and 40% by weight of polymer, the light redirecting features can be formed in a precise manor with developing the birefringence of the polymer. Below 10% by weight of polymer, the stress/strain during embossing results in significant birefringence. Above 50% solvent content by weight of polymer, the precision light redirecting features have difficulty maintaining critical dimensions such as ridge line and pitch during drying of the optical film. Further, the retained solvent content may be located in a skin layer located on embossing surface layer. The skin layer containing 15 to 40% solvent by weight of polymer preferably has a thickness that is at least 50% the height of the feature. The solvent content of the skin layer preferably can be accomplished by solvent re-wetting of a surface layer to obtain a solvent content between 15 and 40% by weight of polymer prior to embossing. Solvent re-wetting of the skin layer allows for efficient conveyance of the low birefringent polymer while providing a surface for the formation of low birefringent redirecting features.

In a further embodiment of the invention, preferably the low birefringent polymer is sufficiently dried to remove the remaining solvent from the casting surface prior to embossing. Removal of substantially of the solvent from the polymer allows the low birefringent polymer to be subsequently embossed is a separate manufacturing operation where the embossing variables, mainly pressure and embossing speed can be optimized separate from the typically slow polymer solvent casting process. Further, embossing in a separate operation allows for the use of a embossing roller that can be smaller in diameter that large casting surface rollers, thus lower the expense for precision patterning of the casting surface.

In another embodiment of the invention, the low birefringent polymer is preferably cast onto a polymer carrier sheet. Casting on a polymer carrier sheet allows for high residual solvent content to be maintained in the low birefringent polymer with a loss in conveyance efficiency. Without the carrier sheet, a careful balance between high solvent content to create embossed surface features which are low in birefringence and conveyance as high solvent loading typically reduces the mechanical strength of a cast polymer web. Further, it has been shown that utilizing a carrier web serves to protect the side opposite the light redirecting surface features during conveyance through the embossing operation and a roll winder. The carrier sheet used for the casting of the low birefringent polymer preferably is strong and smooth. The carrier sheet preferably has a tensile modulus of at least 1200 MPa (utilizing ISO 527-1 and 527-2 at 50 mm/min) and has a surface roughness (Ra) preferably less than 200 nm. Surface roughness, in particular random surface roughness greater than 400 nm has been shown to diffuse transmitted light reducing the efficiency of the redirecting film.

Polymer carrier webs are used to protect the side opposite the features during formation and subsequent conveyance, provide a smooth casting surface to maintain the optical efficiency of the redirecting film and allow high solvent loading to be utilized for the formation of low birefringent features. In some display applications, an optical pattern opposite the redirecting features such as light diffusion lenses may be helpful in increasing vertical or horizontal gain. In such a case, the carrier web is preferable patterned. It has been found that the cast coated low birefringent polymer replicate a pattern in the carrier web with high fidelity and therefore is an efficient method for patterning both sides of the redirecting film. Preferred patterns in the carrier web are less than 20 micrometers in height and have an aspect ratio less than 4:1 to facilitate ease of removal of the carrier web.

In a preferred alternate method for the formation of low birefringent polymers a process of forming a low birefringent light-redirecting film comprising simultaneously melt casting a low birefringent polymer and at least one sacrificial surface polymer layer polymer against a roller containing concave features having two or more sides that form a crevice line, removing the composite polymer sheet from said roller to form a composite having integral features, wherein the features have two or more sides that form a ridge line, and stripping said at least one sacrificial layer, wherein the optical film has light leakage through crossed polarizers of less than 1.0%. It has been found that during the melt casting process, the majority of the melt flow induced birefringence is developed as the melt flow is contacted with the surface of the extrusion die and any strain placed on the melt curtain during the casting of the polymer onto the precision patterned roller. By providing a sacrificial polymer layer on the surface layer, the majority of the birefringence is developed in the sacrificial layers, which can be removed in a subsequent sacrificial stripping step, achieving a melt casted polymer that has low birefringence. The sacrificial polymer may be on the side opposite the features or on both sides of the melt extruded light redirecting film.

The properties and pattern of the optical elements of light redirecting films may also be customized to optimize the light redirecting films for different types of light sources which emit different light distributions, for example, one pattern for single bulb laptops, another pattern for double bulb flat panel displays, CCFL light source, LED light source and so on.

Further, light redirecting film systems are provided in which the orientation, size, position and/or shape of the curved wedge shaped protuberances of the light redirecting films are tailored to the light output distribution of a backlight or other light source to reorient or redirect more of the incident light from the backlight within a desired viewing angle. Also, the backlight may include individual optical deformities that redirect light along one axis and the light redirecting films may include curved wedge shaped protuberances that redirect light along another axis perpendicular to the one axis.

In some prior applications, LCD devices use two grooved film layers rotated relative to each other such that the grooves in the respective film layers are at 90 degrees relative to each other. The reason for this is that a grooved light redirecting film will only redistribute, towards the direction normal to the film surface, the components of the incident light distribution traveling in a plane perpendicular to the refracting surfaces of the grooves. Therefore, to redirect light toward the normal of the film surface in two dimensions, two grooved film layers rotated 90 degrees with respect to each other are needed, one film layer to redirect light traveling in a plane perpendicular to the direction of its grooves and the other film layer to redirect light traveling in a plane perpendicular to the direction of its grooves.

The light redirecting film of the invention can also be used with a lighting system. Light is produced by the light source, which can be light bulb, organic or inorganic light emitting diode, solid-state light source, or any other method of producing light. The light exits the light source and enters the light redirecting film where is it recycled and redirected. This could be used for indoor lighting applications such as task lighting or spot lighting for pictures or any other lighting application that requires more redirected light than what the lighting source is outputting.

The light redirecting film can also be used in a display system. The display can be any form of display such as a liquid crystal display, organic light emitting diode display. An organic light emitting diode display is preferred so that for one-viewer situations, the light from the OLED can be redirected such that the one-viewer has a brighter display on-axis. The display can be active or static. The light redirecting film serves to redirect the light from the display on axis.

Visually, the moiré effect refers to a geometrical interference between two similar spatial patterns. The interference is most apparent between patterns that contain the same or nearly the same periodicities. The patterns observed when viewing cascaded transmission screens, such as picket fences, are examples of moiré. Upon analysis of these patterns it is clear that the moiré pattern is a result of the sum and differences of the screens' periodic components. The phenomenon is often referred to as beats or the beating of two patterns. The resulting observable moiré pattern has a lower frequency than either of the two original patterns, has a amplitude that is dependent on the strength of the harmonic components that are beating and an orientation that depends on the relative orientation of the two patterns. For example the moiré pattern produced by two square wave transmission gratings of equal period, p, vertically aligned and oriented at angle, θ, with respect to each other will be horizontally oriented with a period approximately equal to p/θ and have a line shape that is given by the convolution of the individual grating line shape. Obviously as the angle goes to zero the period gets infinitely width. However, for perfectly aligned screens moiré is observable when they have nearly identical periods. The resulting moiré pattern will have a period equal to p1*p2/(p1−p2), where p1 and p2 are the two screen period. For example if grating 1 has a period p1=0.05 mm and grating 2 has a period p2=0.0501 mm, the resulting moiré period will be 25 mm.

Gratings with apparently significantly different periods can produce moiré effects if they have harmonics that are close in frequency. A square wave screen having period p1 will have harmonics that are multiples, n, of 1/p1, that is n/p1. The beating of these harmonics with the fundamental of a second screen of period, p2, will produce beats having period equal to p1*p2/(n*p2−p1). Consider the fifth harmonic (n=5) of a screen having period p1=0.25 mm and a screen with period p2=0.0501. The resulting moiré period is 25 mm.

Whether or not the resulting moiré will actually be observed depends on the resulting period and modulation. The combined visual impact of these parameters is contained in the Van Nes Bouman curve of contrast modulation threshold. This curve indicates the minimum contrast required for observe ability as a function of spatial given in cycles/degree. Generally the eye is most sensitive to frequencies between 2 and 10 cycles/degree, peaking at 5 cycles/deg. In this range the visual threshold is ˜0.1% modulation. To convert the spatial period into spatial frequency in cycles/degree requires introducing the observers viewing distance. A viewing distance of 18 inches, one degree subtends ˜8 mm. Thus dividing 8 mm by the spatial period of the moiré pattern in mm yields its spatial frequency in cycles/degree. For the above examples, the moiré period of 25 mm corresponds to ˜0.32 cycles/degree. At this spatial frequency the visual threshold is ˜1% modulation. From Fourier analysis, pure square wave screens will have ˜1.8% modulation, making slightly visible.

So the key parameters regarding the visibility of the moiré pattern are the spatial frequency in cycles/degree and its modulation. Since these properties are derived from the underlying screens their construction parameters are key. As discussed in the examples above, straight line screens or screens that vary in only one direction will produce straight-line moiré patterns. The introduction of a curved structure into the pattern as in the wedge makes the pattern two-dimensional. Periodic placements will result in two-dimensional harmonic components. It will be the beating of these periodic components with the periodicities of a TFT black matrix structure that could potentially produce moiré patterns. This two-dimensional pattern can be viewed as overlapping diamonds or sinusoids. As the long dimension lengthens the pattern becomes one-dimensional and a moiré pattern can develop as described above. As the pattern is shortened the screen gain is reduced and therefore is not of interest. This in-between length wedge pattern can result in a moiré pattern as described above. The is similar to the moiré developed between the TFT and a linear screen except that the curved structure of the apple wedge element results in wider line shaped due to the convolution operation and as a result contrast can be lower. Also randomization that is introduced helps break the periodicity further reducing the observation of moiré.

The invention may be used in conjunction with any liquid crystal display devices, typical arrangements of which are described in the following. Liquid crystals (LC) are widely used for electronic displays. In these display systems, an LC layer is situated between a polarizer layer and an analyzer layer and has a director exhibiting an azimuthal twist through the layer with respect to the normal axis. The analyzer is oriented such that its absorbing axis is perpendicular to that of the polarizer. Incident light polarized by the polarizer passes through a liquid crystal cell is affected by the molecular orientation in the liquid crystal, which can be altered by the application of a voltage across the cell. By employing this principle, the transmission of light from an external source, including ambient light, can be controlled. The energy required to achieve this control is generally much less than that required for the luminescent materials used in other display types such as cathode ray tubes. Accordingly, LC technology is used for a number of applications, including but not limited to digital watches, calculators, portable computers, electronic games for which light weight, low power consumption and long operating life are important features.

The light redirecting films of the present invention also have significant architectural uses such as providing appropriate light for work and living spaces. In certain applications, the redirecting film can be used to redirect or direct sunlight entering a structure to specific areas.

Skin layers or coatings may also be added to impart desired barrier properties to the resulting film or device. Thus, for example, barrier films or coatings may be added as skin layers, or as a component in skin layers, to alter the transmissive properties of the film or device towards liquids, such as water or organic solvents, or gases, such as oxygen or carbon dioxide.

Skin layers or coatings may also be added to impart or improve abrasion resistance in the resulting article. Thus, for example, a skin layer comprising particles of silica embedded in a polymer matrix may be added to an optical film produced in accordance with the invention to impart abrasion resistance to the film, provided, of course, that such a layer does not unduly compromise the optical properties required for the application to which the film is directed.

Skin layers or coatings may also be added to impart or improve puncture and/or tear resistance in the resulting article. Thus, for example, in embodiments in which the outer layer of the optical film contains a co-polymer of PEN (coPEN) as the major phase, a skin layer of monolithic coPEN may be coextruded with the optical layers to impart good tear resistance to the resulting film. Factors to be considered in selecting a material for a tear resistant layer include percent elongation to break, Young's modulus, tear strength, adhesion to interior layers, percent transmittance and absorbance in an electromagnetic bandwidth of interest, optical clarity or haze, refractive indices as a function of frequency, texture and roughness, melt thermal stability, molecular weight distribution, melt rheology and coextrudability, miscibility and rate of inter-diffusion between materials in the skin and optical layers, viscoelastic response, relaxation and crystallization behavior under draw conditions, thermal stability at use temperatures, weather-ability, ability to adhere to coatings and permeability to various gases and solvents. Puncture or tear resistant skin layers may be applied during the manufacturing process or later coated onto or laminated to the optical film. Adhering these layers to the optical film during the manufacturing process, such as by a co-extrusion process, provides the advantage that the optical film is protected during the manufacturing process. In some embodiments, one or more puncture or tear resistant layers may be provided within the optical film, either alone or in combination with a puncture or tear resistant skin layer.

The skin layers may be applied to one or two sides of the extruded blend at some point during the extrusion process, i.e., before the extruded blend and skin layer(s) exit the extrusion die. This may be accomplished using conventional co-extrusion technology, which may include using a three-layer co-extrusion die. Lamination of skin layer(s) to a previously formed film of an extruded blend is also possible.

In some applications, additional layers may be co-extruded or adhered on the outside of the skin layers during manufacture of the optical films. Such additional layers may also be extruded or coated onto the optical film in a separate coating operation, or may be laminated to the optical film as a separate film, foil, or rigid or semi-rigid substrate such as polyester (PET), acrylic (PMMA), polycarbonate, metal, or glass.

Various functional layers or coatings may be added to the optical films and devices of the present invention to alter or improve their physical or chemical properties, particularly along the surface of the film or device. Such layers or coatings may include, for example, slip agents, low adhesion backside materials, conductive layers, antistatic coatings or films, barrier layers, flame retardants, UV stabilizers, abrasion resistant materials, optical coatings, or substrates designed to improve the mechanical integrity or strength of the film or device.

The films and optical devices of the present invention may be given good slip properties by treating them with low friction coatings or slip agents, such as polymer beads coated onto the surface. Alternately, the morphology of the surfaces of these materials may be modified, as through manipulation of extrusion conditions, to impart a slippery surface to the film; methods by which surface morphology may be so modified are described in U.S. Ser. No. 08/612,710.

In some applications, as where the optical films of the present invention are to be used as a component in adhesive tapes, it may be desirable to treat the films with low adhesion backsize (LAB) coatings or films such as those based on urethane, silicone or fluorocarbon chemistry. Films treated in this manner will exhibit proper release properties towards pressure sensitive adhesives (PSAs), thereby enabling them to be treated with adhesive and wound into rolls. Adhesive tapes made in this manner can be used for decorative purposes or in any application where a diffusely reflective or transmissive surface on the tape is desirable.

The films and optical devices of the present invention may also be provided with one or more conductive layers. Such conductive layers may comprise metals such as silver, gold, copper, aluminum, chromium, nickel, tin, and titanium, metal alloys such as silver alloys, stainless steel, and inconel, and semiconductor metal oxides such as doped and un-doped tin oxides, zinc oxide, and indium tin oxide (ITO).

The films and optical devices of the present invention may also be provided with antistatic coatings or films. Such coatings or films include, for example, V₂O₅ and salts of sulfonic acid polymers, carbon or other conductive metal layers.

The optical films and devices of the present invention may also be provided with one or more barrier films or coatings that alter the transmissive properties of the optical film towards certain liquids or gases. Thus, for example, the devices and films of the present invention may be provided with films or coatings that inhibit the transmission of water vapor, organic solvents, O₂, or CO₂ through the film. Barrier coatings will be particularly desirable in high humidity environments, where components of the film or device would be subject to distortion due to moisture permeation.

The optical films and devices of the present invention may also be treated with flame retardants, particularly when used in environments, such as on airplanes that are subject to strict fire codes. Suitable flame retardants include aluminum trihydrate, antimony trioxide, antimony pentoxide, and flame retarding organophosphate compounds.

The optical films and devices of the present invention may also be provided with abrasion-resistant or hard coatings, which will frequently be applied as a skin layer. These include acrylic hardcoats such as Acryloid A-11 and Paraloid K-120N, available from Rohm & Haas, Philadelphia, Pa.; urethane acrylates, such as those described in U.S. Pat. No. 4,249,011 and those available from Sartomer Corp., Westchester, Pa.; and urethane hardcoats obtained from the reaction of an aliphatic polyisocyanate (e.g., Desmodur N-3300, available from Miles, Inc., Pittsburgh, Pa.) with a polyester (e.g., Tone Polyol 0305, available from Union Carbide, Houston, Tex.).

The optical films and devices of the present invention may further be laminated to rigid or semi-rigid substrates, such as, for example, glass, metal, acrylic, polyester, and other polymer backings to provide structural rigidity, weather-ability, or easier handling. For example, the optical films of the present invention may be laminated to a thin acrylic or metal backing so that it can be stamped or otherwise formed and maintained in a desired shape. For some applications, such as when the optical film is applied to other breakable backings, an additional layer comprising PET film or puncture-tear resistant film may be used.

The optical films and devices of the present invention may also be provided with shatter resistant films and coatings. Films and coatings suitable for this purpose are described, for example, in publications EP 592284 and EP 591055, and are available commercially from 3M Company, St. Paul, Minn.

Various optical layers, materials, and devices may also be applied to, or used in conjunction with, the films and devices of the present invention for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors.

The films and other optical devices made in accordance with the invention may also include one or more anti-reflective layers or coatings, such as, for example, conventional vacuum coated dielectric metal oxide or metal/metal oxide optical films, silica sol gel coatings, and coated or co-extruded antireflective layers such as those derived from low index fluoropolymers such as THV, an extrudable fluoropolymer available from 3M Company (St. Paul, Minn.). Such layers or coatings, which may or may not be polarization sensitive, serve to increase transmission and to reduce reflective glare, and may be imparted to the films and optical devices of the present invention through appropriate surface treatment, such as coating or sputter etching. A particular example of an antireflective coating is described in more detail in Examples 132-133.

In some embodiments of the present invention, it is desired to maximize the transmission and/or minimize the specular reflection for certain polarizations of light. In these embodiments, the optical body may comprise two or more layers in which at least one layer comprises an anti-reflection system in close contact with a layer providing the continuous and disperse phases. Such an anti-reflection system acts to reduce the specular reflection of the incident light and to increase the amount of incident light that enters the portion of the body comprising the continuous and disperse layers. Such a function can be accomplished by a variety of means well known in the art. Examples are quarter wave anti-reflection layers, two or more layer anti-reflective stack, graded index layers, and graded density layers. Such anti-reflection functions can also be used on the transmitted light side of the body to increase transmitted light if desired.

The films and optical devices of the present invention may be protected from UV radiation through the use of UV stabilized films or coatings. Suitable UV stabilized films and coatings include those that incorporate benzotriazoles or hindered amine light stabilizers (HALS) such as Tinuvin™ 292, both of which are available commercially from Ciba Geigy Corp. Other suitable UV stabilized films and coatings include those that contain benzophenones or diphenyl acrylates, available commercially from BASF Corp., Parsippany, N.J. Such films or coatings will be particularly important when the optical films and devices of the present invention are used in outdoor applications or in luminaries where the source emits significant light in the UV region of the spectrum.

The films and other optical devices made in accordance with the present invention may be subjected to various treatments which modify the surfaces of these materials, or any portion thereof, as by rendering them more conducive to subsequent treatments such as coating, dying, metallizing, or lamination. This may be accomplished through treatment with primers, such as PVDC, PMMA, epoxies, and aziridines, or through physical priming treatments such as corona, flame, plasma, flash lamp, sputter-etching, e-beam treatments, or amorphizing the surface layer to remove crystallinity, such as with a hot can.

The films and optical devices of the present invention may be treated with inks, dyes, or pigments to alter their appearance or to customize them for specific applications. Thus, for example, the films may be treated with inks or other printed indicia such as those used to display product identification, advertisements, warnings, decoration, or other information. Various techniques can be used to print on the film, such as screen printing, letterpress, offset, flexographic printing, stipple printing, laser printing, and so forth, and various types of ink can be used, including one and two component inks, oxidatively drying and UV-drying inks, dissolved inks, dispersed inks, and 100% ink systems.

The appearance of the optical film may also be altered by coloring the film, such as by laminating a dyed film to the optical film, applying a pigmented coating to the surface of the optical film, or including a pigment in one or more of the materials (e.g., the continuous or disperse phase) used to make the optical film.

Optical brighteners such as dyes that absorb in the UV and fluoresce in the blue region of the color spectrum are preferred. Optical brightener dispersed in the polymer film or coated as a single layer or dispersed in a thin polymer layer provides the desired blue coloration by shifting UV light energy created by device light sources such as CCFL into the preferred blue light energy.

Optical brightener added amounts between 0.1 and 0.5% weight of polymer have been shown to provide the desired blue coloration to the optical film. Dispersion of the optical brightener into the base polymer can be accomplished by known polymer compounding technology. The dispersion quality has been shown to increase the effectiveness of the optical brightener and provide the desired blue coloration to transmitted light. In a preferred embodiment of the invention, the optical brightener is added to a thin skin layer opposite the side containing the protuberances. By concentrating the optical brightener in a thin layer, the uniformity of output light is improved compared to dispersion of the optical brightener in the entire light redirecting film.

Preferred optical brighteners are substantially colorless, fluorescent, organic compound that absorbs ultraviolet light and emits it as visible blue light. Examples include but are not limited to derivatives of 4,4′-diaminostilbene-2,2′-disulfonic acid, coumarin derivatives such as 4-methyl-7-diethylaminocoumarin, 1-4-Bis (O-Cyanostyryl) Benzol and 2-Amino-4-Methyl Phenol. Since optical brighteners absorbs ultraviolet light and emits it as visible blue light, the light source of a display device that utilizes the invention materials preferably emits UV light energy. Further, in a LCD display device, the liquid crystals are sensitive to UV light energy. A redirecting film containing an optical brightener serves to protect the sensitive liquid crystals as UV energy from the backlight is absorbed by the optical brightener and typically emitted in the blue region of the electro-magnetic spectrum.

In another preferred embodiment of the invention, the optical film comprises a blue pigment. A unique feature of this invention is the particle size of the pigments used to tint the imaging layers. The pigments are preferable milled into a particle size less than 1.0 micrometers and more preferably less than 100 nanometers to improve the dispersion quality and to improve the light absorption characteristics of the pigments. Surprisingly, it has been found that when the pigments used in this invention were milled to less than 0.1 micrometers, the unwanted light absorption of the pigments were reduced producing pigments that were more efficient. Blue pigments can be coated on the optical film in a thin blue color layer or dispersed in the optical film polymer.

Suitable pigments used in this invention can be any inorganic or organic, colored materials, which are practically insoluble in the medium in which they are incorporated. The preferred pigments are organic, and are those described in Industrial Organic Pigments: Production Properties, Applications by W. Herbst and K. Hunger, 1993, Wiley Publishers. These include: Azo Pigments such as monoazo yellow and orange, diazo, naphthol, naphthol reds, azo lakes, benzimidazolone, disazo condensation, metal complex, isoindolinone and isoindoline, Polycyclic Pigments such as phthalocyanine, quinacridone, perylene, perinone, diketopyrrolo pyrrole and thioindigo, and Anthrquinone Pigments such as anthrapyrimidine, flavanthrone, pyranthrone, anthanthrone, dioxazine, triarylcarbodium and quinophthalone. The most preferred pigments are the anthraquinones such as Pigment Blue 60, phthalocyanines such as Pigment Blue 15, 15:1, 15:3, 15:4 and 15:6, as listed in NPIRI Raw Materials Data Handbook, Vol. 4. Pigments, 1983, National Printing Research Institute.

The mill utilized to produce nanometer sized pigments can be for example, a ball mill, media mill, attritor mill, vibratory mill or the like. The mill is charged with the appropriate milling media such as, for example, beads of silica, silicon nitride, sand, zirconium oxide, yttria-stabilized zirconium oxide, alumina, titanium, glass, polystyrene, etc. The bead sizes typically range from 0.25 to 3.0 mm in diameter, but smaller media can be used if desired. The premix is milled until the desired particle size range is reached.

The solid colorant particles are subjected to repeated collisions with the milling media, resulting in crystal fracture, de-agglomeration, and consequent particle size reduction. The solid particle dispersions of the colorant should have a final average particle size of less than 1 micrometer, preferably less than 0.1 micrometers, and most preferably between 0.01 and 0.1 micrometers. Most preferably, the solid colorant particles are of sub-micrometer average size. Solid particle size between 0.01 and 0.1 provides the best pigment utilization and had a reduction in unwanted light absorption compared to pigments with a particle size greater than 1.2 micrometers.

Other additional layers that may be added to alter the appearance of the optical film include, for example, diffusing layers, holographic images or holographic diffusers, and metal layers. Each of these may be applied directly to one or both surfaces of the optical film, or may be a component of a second film or foil construction that is laminated to the optical film. Alternately, some components such as opacifying or diffusing agents, or colored pigments, may be included in an adhesive layer that is used to laminate the optical film to another surface.

The films and devices of the present invention may also be provided with metal coatings. Thus, for example, a metallic layer may be applied directly to the optical film by pyrolysis, powder coating, vapor deposition, cathode sputtering, ion plating, and the like. Metal foils or rigid metal plates may also be laminated to the optical film, or separate polymeric films or glass or plastic sheets may be first metallized using the aforementioned techniques and then laminated to the optical films and devices of the present invention.

In addition to the films, coatings, and additives noted above, the optical materials of the present invention may also comprise other materials or additives as are known to the art. Such materials include binders, coatings, fillers, compatibilizers, surfactants, anti-microbial agents, foaming agents, reinforcers, heat stabilizers, impact modifiers, plasticizer, viscosity modifiers, and other such materials.

The following examples illustrate the practice of this invention. They are not intended to be exhaustive of all possible variations of the invention. Parts and percentages are by weight unless otherwise indicated.

### EXAMPLES

In this example a low birefringent polymer containing light redirecting features is compared to both a prior art UV cured acrylate coated oriented PET light redirecting film and a melt extruded light redirecting film utilizing a crossed TFT grade absorptive polarizers. This example will demonstrate a redirecting film that is low in birefringence will change the polarization state of light passing through the film less than prior art materials and manufacturing methods thus allowing for higher on-axis optical gain. The invention material enables the film to be used in situations where light redirecting is desired while maintaining the polarization characteristics of the light.

### Control

The control was a typical 125 micrometer thick, thin film transistor (TFT) grade cellulose tri-acetate (TAC) for LCD. The TAC did not have any surface coatings or surface patterns on both flat surfaces of the TAC.

### Invention Example 1

The invention material (low birefringence redirecting film) was constructed by methylene chloride re-wetting the surface of the above 125 micrometer thick TFT grade cellulose tri-acetate for LCD. The approximate solvent content in the first 25 micrometers depth in film was 18% by weight of cellulose tri-acetate polymer. A 5 cm×5 cm electroformed tool containing precision light redirecting features was pressed into the surface of the solvent re-wetted cellulose tri-acetate under a pressure of 1,379 kPa for 30 seconds. No additional heat was added. The light direction features created were, on average, 950 micrometers long, 44 micrometers wide, and 22 micrometers high with a 90 degree included angle. The features were random, overlapping, and intersecting across the surface of the film such that the distance between the highest points of two adjacent features had an average pitch of approximately 22 micrometers.

### Comparison Example 1

Melted extrusion-grade polycarbonate was extruded into a nip between a precision patterned nickel roller and a smooth pressure roller. The resultant redirecting film was approximately 125 micrometers thick with a patterned side and a smooth side. The melt extruded redirecting film contained features that individually were, on average, 950 micrometers long, 44 micrometers wide, and 22 micrometers high with a 90 degree included angle. The features were random, overlapping, and intersecting across the surface of the film such that the distance between the highest points of two adjacent features had an average pitch of approximately 22 micrometers.

### Comparison Example 2

The light redirecting film utilized in this example was a commercially available brightness enhancement film, the BEF II™ available from 3M. The BEF II is a dual layer structure (that may have a third layer for adhesion between the two layers) of an approximately 100 micrometer oriented polyester (PET) base layer with an approximately 25 micrometer UV cured polyacrylate layer coated and cured on the PET layer containing the light redirecting features. The features are continuous linear prisms with a pitch of 50 micrometers, height of 25 micrometers, and an included angle of 90 degrees.

The test to determine how much of the light passing through the examples changed polarization was measured as follows. Two TFT grade absorptive polarizers were crossed and a total light transmission measurement (measured at 550 nanometers) was taken at the normal to the films. Un-polarized light is incident on the first absorptive polarizer and the detector is behind the second absorptive polarizer. If the polarizers were perfect, one would expect 0% of the light to exit the crossed polarizers normal to the surface of the polarizers. The percent total light transmission at the normal to the films was measured at 0.03%, which indicates some small lack of efficiency of the absorptive polarizers. Next, a piece of TAC and the examples films were placed one at a time between the two polarizers. The amount of light exiting the films (as a percent of the light entering the films) is the amount of light that was converted from the first polarization state of light to the second. The higher light transmission indicates higher-birefringence as the material between the cross polarizers changes the state of polarization of the light from the first-polarizer. All of the materials tested including the invention materials and control materials were substantially transparent and thus the majority of the increase/decrease in light transmission is related to the level of birefringence. The test results for the control, the invention example, and the comparison examples are listed in Table 1 below.

TABLE 1

| | Total light transmission through |
|---|---|
| Sample | crossed polarizers at 550 nm (%) |
| Control | 0.06 |
| Invention Example 1 | 0.12 |
| Comparison Example 1 | 4.8 |
| Comparison Example 2 | 9.4 |

As the data above indicates, the invention example, low birefringence redirecting film, provides a significant advantage compared to both of the comparison examples as the low birefringence redirecting film did not significantly alter the polarization state of light established by the first absorptive polarizer compared to the redirecting film control materials. The control of the un-patterned TAC yielded a result typical to LCD cellulose tri-acetate materials. The light transmission is low through crossed polarizers because the birefringence is low due to the low birefringence of the polymer and the preparation method that induces very low stress/strain on the polymer. Unexpectedly, the invention example where the precision light redirecting features were formed in the TAC increased the birefringence only slightly compared to the control light redirecting materials resulting in very little light leakage through the crossed polarizers. The melt extruded formed light redirecting film (comparison example 1) is lower in birefringence than the oriented and coated light redirecting film (comparison example 2) because the polycarbonate utilized in the melt formed redirecting film and the lower stress/strain manufacturing method utilized in forming melt extrusion redirecting film compared to comparison example 2. Oriented polyester is high in birefringence because of the aromatic polymer (polyester) and the larger amounts of stress/strain placed on the film during the orientation step during manufacturing.

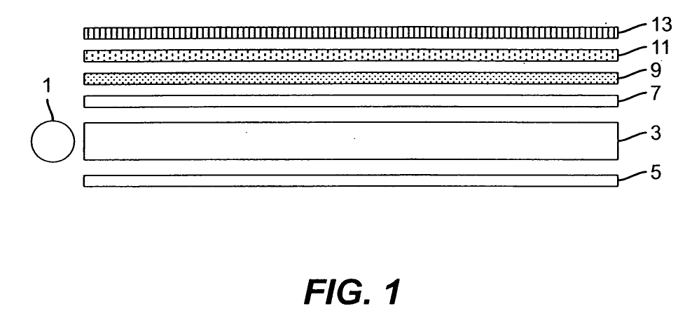

FIG. 1 shows a cross-section of one configuration the backlight section of a liquid crystal display that was tested. The waveguide 3 (Sharp 10.5″ waveguide plate) receives light from the cold cathode fluorescent tube (CCFL) 1. A white reflector 5 is on the backside of the waveguide plate 3. On the front side of the waveguide plate 3 there are in order from closest to the waveguide to further from the waveguide, a diffuser film 7, the light redirecting film to be tested 9, a reflective polarizer 11 (DBEF-E available from 3M), and an absorptive polarizer 13. On top of the absorptive polarizer is the liquid crystal section of the LCD, not shown.

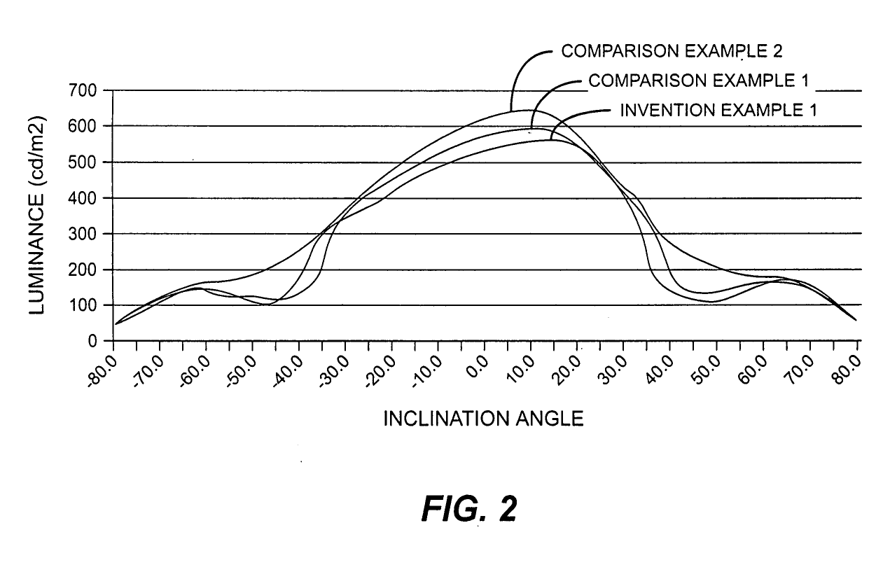

FIG. 2 shows a graph of a cross section of an Eldim plot taken perpendicular to the CCFL of the backlight configuration of FIG. 1. The configuration shown in FIG. 1 is a common stack of backlight optical films with the light redirecting film redirecting light the is not polarized (because light passes through the light redirecting film before any of the polarizing elements. The graph shows the invention example 1 compared to the comparison examples 1 and 2. Comparison example 2, the BEF II 90/50 from 3M, had the highest brightness, followed by comparison example 1 and then invention example 1.

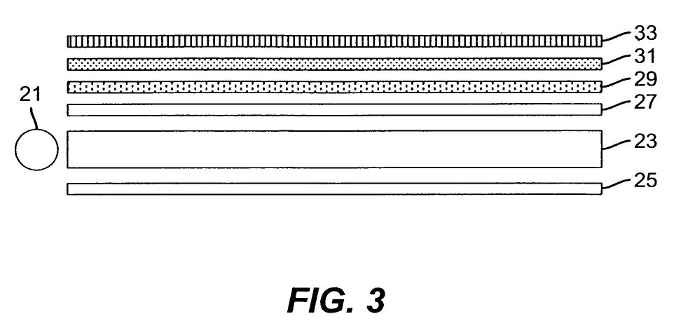

However, when the films were tested between the reflective polarizer and the absorptive polarizer, the results showed a superior performance of the invention example. FIG. 3 shows a cross-section of one configuration the backlight section of a liquid crystal display that was tested. The waveguide 23 (Sharp 10.5″ waveguide plate) receives light from the cold cathode fluorescent tube (CCFL) 21. A white reflector 25 is on the backside of the waveguide plate 23. On the front side of the waveguide plate 23 there are in order from closest to the waveguide to further from the waveguide, a diffuser film 27, a reflective polarizer 29 (DBEF-E available from 3M), the light redirecting film to be tested 31, and an absorptive polarizer 33. On top of the absorptive polarizer is the liquid crystal section of the LCD, not shown. In this configuration, light passes through the reflective polarizer 29 first, polarizing the light, and then enters the light redirecting film 31, and then the reflective polarizer 33.

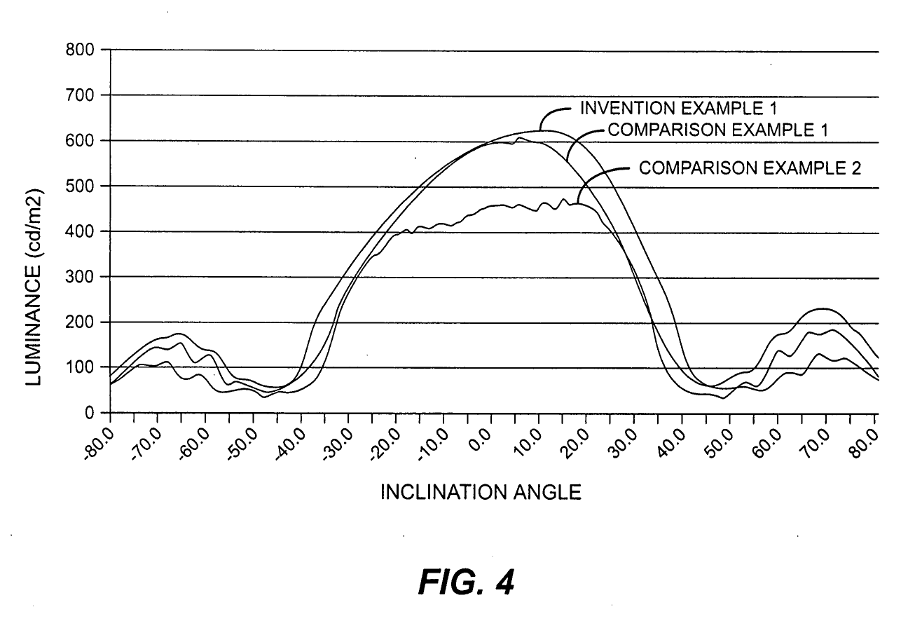

FIG. 4 shows a cross section of an Eldim plot taken perpendicular to the CCFL. The graph of FIG. 4 shows that in the configuration of FIG. 3, the invention example had the highest luminance, followed by comparison 1 and then comparison 2. The invention example 1 had the highest luminance because it redirected the light (involving reflection, refraction, and light recycling) with the least impact to the polarization state of light from the reflective polarizer. While, the film was tested in a system with a reflective polarizer and an absorptive polarizer, the film would have the same impact to a backlight system in which the waveguide plate emitted polarized light.

A light redirecting film that has low birefringence has significant commercial value in that, for example, the low birefringence redirecting film can be utilized in display systems that utilize polarized light such as LCD display devices or OLED display devices. Further, the light redirecting film of the invention, because of the low birefringence, can be utilized inside of the absorptive polarizer and used to redirect light prior to the liquid crystal cell. Because the reflective polarizer comprises cellulose tri-acetate, the redirecting film of the invention can be utilized to construct an absorptive polarizer that redirects light as the cellulose tri-acetate material utilized in the invention is compatible with the construction of dyed and oriented reflective polarizers that are common to LCD display devices.

Additionally, while the example shows a total light transmission of 0.12 for the invention material, higher solvent content in either a skin layer of the cellulose tri-acetate or in the bulk of the tri-acetate sheet are contemplated to result in lower birefringence as higher solvent percentage reduces stress/strain induced birefringence and the Tg of the TAC polymer is inversely proportional to the amount of residual solvent contained in the TAC. By lowering the Tg and by reducing the amount of mechanical stress on the film, lower film birefringence is achieved.

Finally, while the example was primarily directed toward a light redirecting film for LCD electronic display devices, the invention also can be utilized for other electronic display devices such as OLED, PLED or cholestric liquid crystal. The low birefringent light direction film is ideally suited for light sources emitting a high degree of polarized light. The low birefringence light redirecting film can also be utilized for applications such as privacy screens, brightness enhancement for indoor lighting, friction control for boat decks, an abrading surface, direction control for automobile lighting and viewing enhancement for eye glasses.

The invention has been described in detail with particular reference to certain preferred embodiments thereof, but it will be understood that variations and modifications can be effected within the spirit and scope of the invention.

1-35. (canceled)

36. A liquid crystal display comprising a backlight section, the backlight section comprising:
a light source for providing light to the display;
a waveguide for receiving the light;
a reflector on a back side of the waveguide for reflecting the light towards normal;
a diffuser film on the front side of the waveguide for diffusing incoming light;
a light redirecting film having a birefringence of between 1.0×10⁻⁵ to 5.0×10⁻³;
a first polarizer crossed from a second polarizer; and
wherein the light redirecting film is provided between the first and second polarizers and the light leakage through the crossed first and second polarizers and the light redirecting film is less than 1.0%.

37. The liquid crystal display of claim 36, wherein the light leakage is between 0.05 to 0.5%.

38. The liquid crystal display of claim 36, wherein the first polarizer is a reflective polarizer.

39. The liquid crystal display of claim 36, wherein the second polarizer is an absorptive polarizer.

40. The liquid crystal display of claim 36, wherein the light redirecting film comprises a cellulose triacetate polymer.

41. The liquid crystal display of claim 36, wherein the light redirecting film comprises a cyclo-olefin.

42. A liquid crystal display comprising a backlight section, the backlight section comprising:
a light source for providing light to the display;
a polarizing waveguide for receiving the light;
a reflector on a back side of the waveguide for reflecting the light towards normal;
a light redirecting film having a birefringence of between 1.0×10⁻⁵ to 5.0×0-3;
an absorptive polarizer crossed from the polarizing waveguide; and
wherein the light redirecting film is provided between the polarizing waveguide and the absorptive polarizer and the light leakage through the crossed polarizing waveguide and the absorptive polarizer, and the light redirecting film is less than 1.0%.

43. A liquid crystal display comprising:
a light source for providing light to the display;
a waveguide for receiving the light;
a reflector on a back side of the waveguide for reflecting the light towards normal;
a diffuser film on the front side of the waveguide for diffusing incoming light;
a light redirecting film having a birefringence of between 1.0×10⁻⁵ to 5.0×10⁻³;
a liquid crystal cell for transmitting polarized light;
a first absorptive polarizer crossed from a second absorptive polarizer; and
wherein the light redirecting film and the liquid crystal cell are provided between the first and second absorptive polarizers and the light leakage through the crossed first and second absorptive polarizers, and the light redirecting film and liquid crystal cell is less than 1.0%.
